(19) United States
(12) Patent Application Publication
(10) Pub. No.: US 2006/0118345 A1
(43) Pub. Date: Jun. 8, 2006

(54) Full hybrid electric car

(76) Inventors: Toshihiro Fukumoto, Tokyo (JP); Yousuke Fukumoto, Tokyo (JP); Keiko Ebato, Tokyo (JP)

Correspondence Address: BROWDY AND NEIMARK, P.L.L.C.;624 NINTH STREET, NW, SUITE 300, WASHINGTON, DC, 20001-5303, US

(21) Appl. No.: 10/526,074

(22) PCT Filed: Sep. 22, 2003
(86) PCT No.: PCT/JP03/12042

§ 371 Date: Sep. 19, 2005

(30) Foreign Application Priority Data
Sep. 26, 2002 (JP) 2002-280419

(51) Int. Cl. B60K 6/00

(52) U.S. Cl. 180/65.2

(57) ABSTRACT

A full hybrid electric car capable of decreasing an environmental pollution and an operation cost as well as a production cost through an increase in heat efficiency of the engine of a vehicle and a reduction in weight of the vehicle, wherein an AC generator (2) is driven by a prime mover (1) to feed an electric power to AC motors (12) and the vehicle is run by the AC motors (12) installed on the wheels of the vehicle or supplementary driven by a DC motor (3) through gears, a steering structure is abolished by the adjustment of the rotational speed of the wheels, the motors of the wheels are controlled by detecting the intention of an operator on a gyrocompass and an accelerometer, or the upper limit values of the rotational speeds of the wheels are set for safety.

### TECHNICAL FIELD

The present invention is a new technology that contributes to the improvement of the safety operation, fuel cost and exhaust reductions of the pollution material as for the car, agriculture, and the wheel and the caterpillar etc. such as the construction engineering works equipment.

The present invention is a technology which is lost the direction conversion device with the engine such as the flywheel, the clutch, the starter and the steering wheel, etc. and the differential device for speed control such as the gear box and differential gears, etc., and achieves all circle drive in the engine easily.

### BACKGROUND ART

In a conventional hybrid car, running by electricity was, so to speak, role as the assistance of the engine to the end when it was starting, climbing up the slope, and the condenser had some room. Electricity was generated to achieve power when the car took a brake and the engine had room.

The hydrogen-powered car as the dream car of next generation has some problems such as the difficulty of treatment of hydrogen (its volatility), the restriction of law regulation for the high pressure gas, the difficulty of the supply of hydrogen gas. In addition, the environmental advantage in case of using hydrogen is obscure judged from the total thermal efficiency from manufacturing to power generation, and some say that manufacturing price of hydrogen fuel cell is not suitable to commercial base.

Further more, the body of the car follows the structure of a conventional car, there was a weak point that the price becomes expensive since it became a bipolar system and heavy on weight.

Since the rotational speed of the engine changed greatly, a conventional hybrid car had the weak point that measures for the purification of the car exhaust become complex.

### PROBLEMS TO BE SOLVED BY THE INVENTION

(Promotion of Green Engineering and Measures to Conserve Energy)

The basis of environmental measures such as vehicles is decided according to turning on heat source what percentage used for the final momentum. The method with high use efficiency is a true environment-friendly technology. The movement efficiency of vehicles depends on whether achieved by how many calories of the heat source in the amount of the kilo-ton of the weight such as persons and the amount of the carried freight. Therefore, it is an advanced environment-friendly vehicle that their weight is light, and the final thermal efficiency is high by the green engineering.

There is no thing that the load to the environment is high such as the accident to other vehicles and to persons etc. which are said to accidents in general. To build the vehicle which doesn't cause an accident easily is big environmental measures.

However, people don't live by only an economic efficiency. Therefore, the riding comfort and the satisfaction at driving are important problems when the vehicles are planned. In the safety plan, it is necessary to equip the mechanically judge device whether the driver's intention agrees with the geography condition, the driving is the operations below the safety standard when the vehicles are planned. When it deviate from the safety standard, the device that compulsorily adjusted to the safety-plan is necessary. When these problems are solved, the riding comfort and the customer satisfaction are improved.

(Concrete Strategy)

Stably driving the engine by the most efficient rotational speed becomes an easy device whose cost is the cheapest and weight is the lightest for the best purification of the vehicle exhaust. Therefore, doing a detailed output adjustment of vehicles by an electric method can make the cost cheap and the device light.

It is efficient that a detailed output adjustment of the motor is transformed by alternating current. However, alternating current can not be stored. Therefore, it is suitable to separate the electrical system in two systems (the A.C. system and the D.C. system). This method has advantage in weight and the cost, and the technology for this method has been widely used each for A.C. system and D.C. system.

### DISCLOSING OF THE INVENTION

The motor uses the power by the A.C. dynamo and rotates stably, which is contributed to the decrease in fuel cost and a decrease in the exhaust of the pollution material. The engine gains the assisted output by the D.C. motor connected with A.C. generator by gears or belts, using the difference of the quantity of electricity by the motor and of electricity assumed to be necessary for the running. When the electricity is generated more than necessary amount, the electricity is stored battery after transforming the electricity generated by the D.C. motor using the power of A.C. generator to the standard voltage.

Rotational speed of each wheel is controlled by the power supply controller which control the motor and by the A.C. motor connected with each wheel by the free light gear-change (at the following as the gear-change). (It is requested as Japanese patent Application No. 2001-135702 by investor Toshihito Fukumoto.) The gear-change gains the biggest result by decreasing the output of the motor and adjusting to obtain the best driving amount, and contributes to a stable driving conventionally only by the difference of the rotational speed of the wheel. The present invention does not depend on the driving stabilizers such as the steering wheel, a manual gear gear-change, a hydraulic torque converter, the no steps type gear-change through a metallic belt and differential gear, etc.

The motors carried in each wheel functions generate the best driving power, work as A.C. generator during slowdown, and controlled by concentrated controlling device to get the best amount of speed change and the maximum amount of power generation by function of gear-change connected with motor.

The electricity that is collected to the A.C. dynamo, generated by D.C. generator connected directly to the A.C. generator is saved in various storage batteries, and recycled as the motive power source of motor that makes control system that applies device used as present hybrid system assist and drive dynamo.

The gyrocompass set up in the body detects the difference of the traveling direction at present and the steering wheel corner that the driver intend, makes the traveling direction change the most stably by changing the rotational speed of each wheel. This control is a technology controlled with a mathematical arithmetic unit.

The accelerometer set up in the body detects the difference between the present speed of the vehicle and the speed that the driver intend, a mathematical arithmetic unit calculates the amount of electric supply to each wheel, and the amount of electric supply is controlled by the control system.

When the numerical value detected by the gyrocompass and the accelerometer set up in the body approaches an overthrow angle in the design and a dangerous value of a horizontal rotation in a horizontal angle of the body or the acceleration to horizontal direction, or the value that the tire grips the road falls below the safety value in the design by situation of the road, the vehicle automatically lowers the speed.

### BEST MODE FOR CARRYING OUT THE INVENTION

To describe the present invention minutely, attached drawings are followed.

### BRIEF DESCRIPTION OF THE DRAWINGS

FIG. 1 shows the method which supplies the amount of electricity that is generated by the A.C. generator (driven directly by the engine) and calculated by arithmetic unit to each wheel needed by driving individually in each wheel through a controller, a power supply stabilization device, and a positive reverse-controller. The A.C. generator has D.C. motor, and charges the storage battery by driving as the D.C. generator when the surplus the controller calculated in the engine or assisted driving source is generated. The A.C. generator becomes the driving source and rotates the D.C. motor when each wheel starts generating electricity as a brake or until the rotational speed has fallen down to the sufficient speed.

FIG. 2 shows the situation in which the A.C. motor is set to an independent axle by the gear-change respectively. The motor acts as a dynamo during braking, and generates the A.C. electricity by the brake power. Therefore, the controller to make the voltage and phase sympathize is needed, and each motor equips phase sympathizer. And it shows the installation concept of the gear-change, the motor, the electrical potential cycle sympathizer, and the voltage tune controller.

FIG. 3 shows the concept of the wheel to adjust the rotational speed of each wheel, to detect the running situation of the vehicle by the equipped gyrocompass and accelerometer, to detect the intention of the driver and the difference of the steering wheel corner and the accelerator corner caused by the direction and speed of the vehicle, and to calculate the momentum with a mathematical arithmetic unit.

FIG. 4 shows the controller's concept chart. The controller is connected with the gyrocompass, the accelerator and the power supply device by a mathematical unit, and controls the amount of power supply and the power generation by the motor connected with an individual wheel. It also calculates the need of electricity for each wheel and the amount of power generation. The result is transmitted to the controller set up in each wheel and the wheel is controlled.

FIG. 5 shows the easy explanation of the present invention.

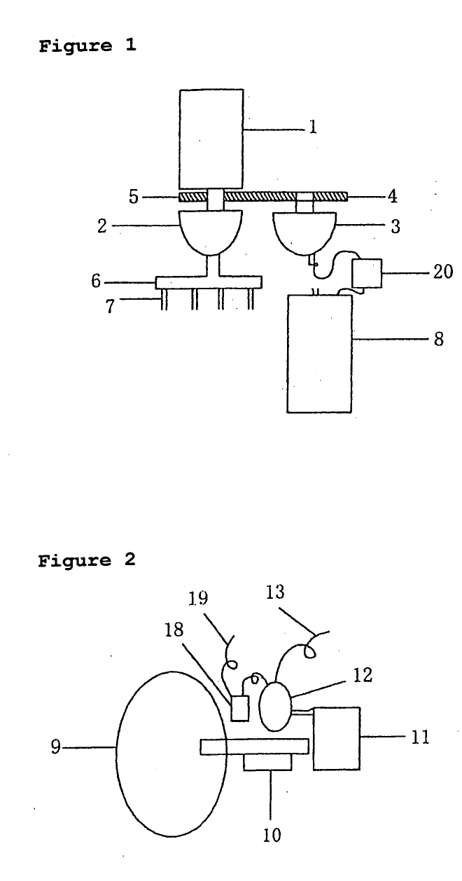

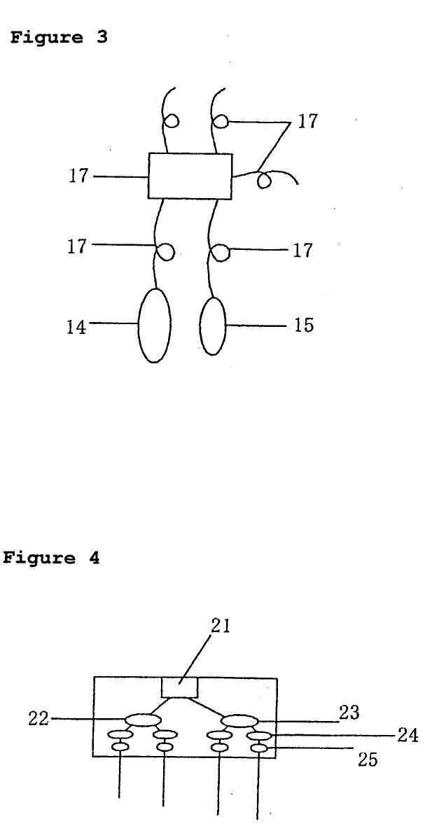

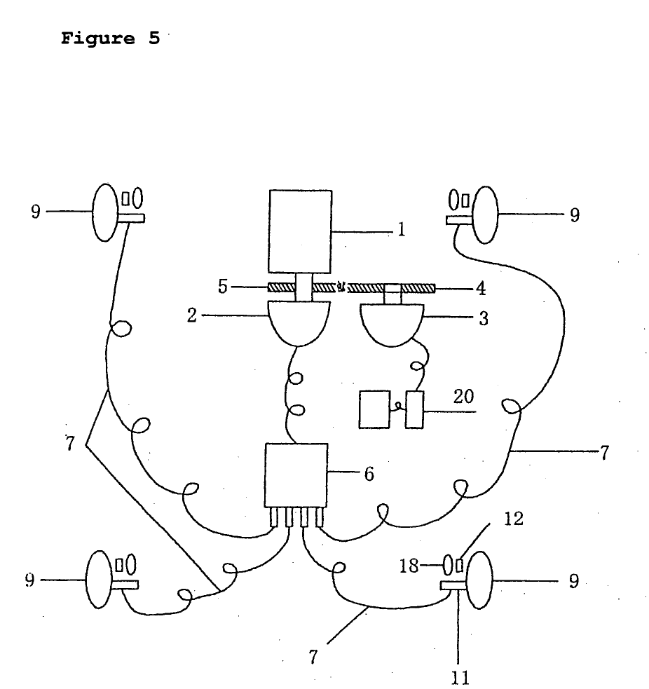

### EASY EXPLANATION OF REFERENCE LETTERS

1 Engine

2 A.C. motor

3 D.C. motor

4 Diving gear for D.C. motor

5 Output adjustment gear for A.C. motor

6 Axle adjustment controller

7 Axle output adjustment wire harness

8 Storage battery

9 Tire, desk wheel and brake equipment

10 Suspension

11 Gear-change

12 A.C. motor

13 Electric power I/O wire harness

14 Gyrocompass

15 Accelerometer

16 Detection device for axle direction, Detection device for the difference of the steering corner and the accelerator corner

17 Wire harness

18 Motor with axle, the gear-change control controller

19 Wire harness for control

20 Voltage stabilization device and input-output control unit for storage battery

21 Arithmetic unit

22 Arithmetic unit of front wheel control

23 Arithmetic unit of rear wheel control

24 Electric power input-output control unit

25 Electric aspect title stabilization device

### INDUSTRIAL APPLICABILITY

When the pattern is set, owing to rotate the engine by the rotational speed in a constant pattern, it can be set by the situation of the occurrence of the vehicle exhaust with few pollution materials and the best performance of the engine on the fuel expenses. Moreover, the driving cost can be decreased because of the stable driving and the best fuel expenses.

It is possible to reduce the driving device of conventional vehicles, so the weight of the vehicles can be reduced, the response by the electrical control can be improved, and the driving operation can be operated as the driver intends. These facts contribute to the inclusion of the safety device to the vehicles.

The time loss decreases compared with mechanical correspondence to correspond to the change in the vehicle output electrically. This improves safety, too.

1. The structure that drives the A.C. dynamo with the motor using the alcohol etc. generated from oil, natural gases, and the plants, and drives the vehicle by A.C. motor by gear-exchange installed in each wheel.

2. The control method by the mathematical operation machine to improve the fuel expenses by driving at the best rotational speed and reduce the pollution material, and the structure to drive the motor by the rotational speed of several kinds of patterns with the combustor efficiency and drive the vehicle by getting the A.C. by the A.C. generator and cope with the change of power consumption by the change of detailed driving situation by driving auxiliary the D.C. motor through the gear to the A.C. generator.

3. The structure that controls the driving direction by adjusting rotational speed of wheel by combining gear-change individually installed in each wheel and A.C. motor and the steering wheel structure of the front wheel is abolished.

4. The structure that achieves the running situation which the driver intends controlled by the mathematical arithmetic unit by controlling the supply of electricity to the motor in each wheel and gear-change, owing to control the rotational speed of each wheel and regard the difference between the steering angle and the accelerator angle which are intended by the driver and the direction of the body detected by the gyrocompass installed in the body and the change of the speed detected by the accelerometer as the difference of momentum.

5. The device that detects the rotational speed of each wheel and keeps the safety in running vehicle by suppress the rotational speed below the safety value when rotational speed exceeds it to the safety value in the vehicle design.
